(19) United States
(12) Patent Application Publication
(10) Pub. No.: US 2021/0051356 A1
(43) Pub. Date: Feb. 18, 2021

(54) PROGRAM RECOMMENDATION METHOD AND LOCAL MACHINE USING THE SAME

(71) Applicant: Novatek Microelectronics Corp., Hsinchu (TW)

(72) Inventors: Chao-Chi Yang, Hsinchu City (TW); Wen-Ching Liao, Hsinchu County (TW); Wei-Te Hu, Hsinchu County (TW); Chi-Yuan Lai, Hsinchu County (TW)

(73) Assignee: Novatek Microelectronics Corp., Hsinchu (TW)

(21) Appl. No.: 16/541,195

(22) Filed: Aug. 15, 2019

(51) Int. Cl. H04N 21/258; H04N 21/45; H04N 21/442

(52) U.S. Cl. CPC H04N 21/25891; H04N 21/44204; H04N 21/4532

(57) ABSTRACT

A program recommendation method applicable to a television is provided. The program recommendation method includes the steps of obtaining information of a user's current watching behavior regarding the program genres in the current time interval of the time intervals for the current time; obtaining information of the user's past personal preference regarding the program genres in one of the time intervals corresponding to the current time interval for the past time; analyzing information of the user's current personal preference regarding the program genres in the current time interval of the time intervals for the current time according to the information of the user's current watching behavior and the information of the user's past personal preference; and generating, and providing one or more recommendations of programs available in the current time interval of the time intervals to the user according to the information of the user's current personal preference.

### BACKGROUND

### Technical Field

The disclosure relates to a recommendation method and a local machine, more specifically, to a program recommendation method applicable to a television and a television using the program recommendation method.

### Description of Related Art

Generally, it is common to use cloud computing in order to recommend the user's favorite programs, such as in YouTube, Netflix, Tencent, and Iqiyi, etc. Therefore, the recommended program list for the user is provided online.

Recently, along with the development of technology, there are many programs and channels on television. It is more and more difficult for the user to pick the right program that the user likes. Hence, how to recommend favorite programs to the users when watching television is one of the main issues that the technical people in the field are trying to solve.

### SUMMARY

The disclosure is directed to a program recommendation method applicable to a local machine and capable of providing a suitable recommendation program list at different time intervals to different users.

The disclosure is directed to a local machine using the program recommendation method.

The disclosure provides a program recommendation method applicable to a television. The program recommendation method includes steps of obtaining information of a user's current watching behavior regarding a plurality of program genres in a current time interval of a plurality of time intervals for a current time; obtaining information of the user's past personal preference regarding the program genres in one of the plurality of time intervals corresponding to the current time interval for a past time; analyzing information of the user's current personal preference regarding the program genres in the current time interval of the plurality of time intervals for the current time according to the information of the user's current watching behavior and the information of the user's past personal preference; and generating, and providing via a display of the television, one or more recommendations of programs available in the current time interval of the plurality of time intervals to the user according to the information of the user's current personal preference.

In one embodiment of the disclosure, the program recommendation method further includes a step of updating the information of the user's past personal preference using the information of the user's current personal preference.

In one embodiment of the disclosure, the program recommendation method further includes a step of receiving a program guide comprising a plurality of programs each belonging to at least one of the program genres.

In one embodiment of the disclosure, the information of the user's current personal preference regarding the program genres in the current time interval of the plurality of time intervals for the current time comprises a plurality of current personal preference values respectively corresponding to the program genres in the current time interval of the plurality of time intervals for the current time.

In one embodiment of the disclosure, the step of generating, and providing via the display of the television, the one or more recommendations of programs available in the current time interval of the plurality of time intervals to the user according to the information of the user's current personal preference includes a step of recommending one or more programs available in the current time interval belonging to one or more of the program genres corresponding to higher current personal preference values.

In one embodiment of the disclosure, the information of the user's current watching behavior regarding the program genres in the current time interval of the plurality of time intervals for the current time includes a plurality of temporary personal preference values respectively corresponding to the program genres in the current time interval of the plurality of time intervals for the current time. The information of the user's past personal preference regarding to the program genres in the one of the plurality of time intervals corresponding to the current time interval for the past time includes a plurality of past personal preference values respectively corresponding to the program genres in the one of the plurality of time intervals corresponding to the current time interval for the past time.

In one embodiment of the disclosure, the step of analyzing the information of the user's current personal preference regarding the program genres in the current time interval of the plurality of time intervals for the current time according to the information of the user's current watching behavior and the information of the user's past personal preference includes a step of calculating each one of the current personal preference values corresponding to one of the program genres according to one of the temporary personal preference values corresponding to the same one of the program genres and one of the past personal preference values corresponding to the same one of the program genres.

In one embodiment of the disclosure, the information of the user's current watching behavior comprises at least one of information of watch time and information of select times in the current time interval of the plurality of time intervals for the current time.

In one embodiment of the disclosure, the step of calculating each one of the current personal preference values corresponding to the one of the program genres according to the one of the temporary personal preference values corresponding to the same one of the program genres and the one of the past personal preference values corresponding to the same one of the program genres includes steps of assigning weights to the one of the past personal preference values and the one of the temporary personal preference values; and calculating the current personal preference according to the one of the past personal preferences, the one of the temporary personal preference values and the weights assigned thereto.

In one embodiment of the disclosure, the step of assigning weights to the one of the past personal preference values and the one of the temporary personal preference values is performed based on user setting information.

In one embodiment of the disclosure, the program recommendation method further includes a step of assigning a default value to the current personal preference value corresponding to a current program genre of the program genres before the user changes the current program genre. The current program genre is the program genre to which a program currently watched by the use belongs and the default value is greater than each of the current personal preference values corresponding to the other ones of the program genres in the current time interval of the plurality of time intervals.

In one embodiment of the disclosure, the program recommendation method further includes a step of searching one or more online videos according to the one or more recommendations of programs provided via the display; and providing, via the display of the television, the one or more online videos to the user.

In one embodiment of the disclosure, the program recommendation method further includes a step of searching one or more online videos according to the information of the user's current personal preference regarding the program genres in the current time interval of the plurality of time intervals for the current time; and providing, via the display of the television, the one or more online videos to the user.

The disclosure provides a program recommendation method applicable to a television. The program recommendation method includes steps of obtaining information of a user's current watching behavior regarding a plurality of program genres in a current time interval of a plurality of time intervals for a current time; analyzing information of the user's current personal preference regarding the program genres in the current time interval of the plurality of time intervals for the current time according to the information of the user's current watching behavior; and generating, and providing via a display of the television, one or more recommendations of programs available in the current time interval of the plurality of time intervals to the user according to the information of the user's current personal preference.

The disclosure provides a television including a display panel, a memory, and a processor. The memory is configured to store information of a user's past personal preference regarding a plurality of program genres in a plurality of time intervals for the past time. The processor is coupled to the memory and the display panel. Additionally, the processor is coupled to obtain information of the user's current watching behavior regarding the program genres in a current time interval of the plurality of time intervals for a current time; obtain, from the memory, the information of the user's past personal preference regarding the program genres in one of the plurality of time intervals corresponding to the current time interval for the past time; analyze information of the user's current personal preference regarding the program genres in the current time interval of the plurality of time intervals for the current time according to the information of the user's current watching behavior and the obtained information of the user's past personal preference; and generate and provide, via the display panel, one or more recommendations of programs available in the current time interval of the plurality of time intervals to the user according to the information of the user's current personal preference.

In one embodiment of the disclosure, the processor is further configured to update the information of the user's past personal preference stored in the memory using the information of the user's current personal preference.

In one embodiment of the disclosure, the television further includes a communication module coupled to the processor and configured to receive a program guide including a plurality of programs each belonging to at least one of the program genres.

In one embodiment of the disclosure, the information of the user's current personal preference regarding the program genres in the current time interval of the plurality of time intervals for the current time comprises a plurality of current personal preference values respectively corresponding to the program genres in the current time interval of the plurality of time intervals for the current time.

In one embodiment of the disclosure, when the processor generates and provides, via the display panel, the one or more recommendations of programs available in the current time interval of the plurality of time intervals to the user according to the information of the user's current personal preference, the processor is configured to recommend one or more programs available in the current time interval belonging to one or more of the program genres corresponding to higher current personal preference values.

In one embodiment of the disclosure, the information of the user's current watching behavior regarding the program genres in the current time interval of the plurality of time intervals for the current time includes a plurality of temporary personal preference values respectively corresponding to the program genres in the current time interval of the plurality of time intervals for the current time. The information of the user's past personal preference regarding to the program genres in the one of the plurality of time intervals corresponding to the current time interval for the past time includes a plurality of past personal preference values respectively corresponding to the program genres in the one of the plurality of time intervals corresponding to the current time interval for the past time.

In one embodiment of the disclosure, when the processor analyzes the information of the user's current personal preference regarding the program genres in the current time interval of the plurality of time intervals for the current time according to the information of the user's current watching behavior and the obtained information of the user's past personal preference, the processor is configured to calculate each one of the current personal preference values corresponding to one of the program genres according to one of the temporary personal preference values corresponding to the same one of the program genres and one of the past personal preference values corresponding to the same one of the program genres.

In one embodiment of the disclosure, the information of the user's current watching behavior includes at least one of information of watch time and information of select times in the current time interval of the plurality of time intervals for the current time.

In one embodiment of the disclosure, when the processor calculates each one of the current personal preference values corresponding to the one of the program genres according to the one of the temporary personal preference values corresponding to the same one of the program genres and the one of the past personal preference values corresponding to the same one of the program genres, the processor is configured to assign weights to the one of the past personal preference values and the one of the temporary personal preference values, and calculate the current personal preference according to the one of the past personal preferences, the one of the temporary personal preference values and the weights assigned thereto.

In one embodiment of the disclosure, the television further includes a user interface coupled to the processor and configured to acquire user setting information. The processor assigns weights to the one of the past personal preference values and the one of the temporary personal preference values based on the user setting information.

In one embodiment of the disclosure, the processor is further configured to assign a default value to the current personal preference value corresponding to a current program genre of the program genres before the user changes the current program genre. The current program genre is the program genre to which a program currently watched by the use belongs and the default value is greater than each of the current personal preference values corresponding to the other ones of the program genres in the current time interval of the plurality of time intervals.

In one embodiment of the disclosure, the processor is further configured to search one or more online videos according to the one or more recommendations of programs provided via the display, and provide, via the display of the television, the one or more online videos to the user.

In one embodiment of the disclosure, the processor is further configured to search one or more online videos according to the information of the user's current personal preference regarding the program genres in the current time interval of the plurality of time intervals for the current time, and provide, via the display of the television, the one or more online videos to the user.

The disclosure provides a television including a display panel and a processor. The processor is coupled to the display panel. The processor is configured to obtain information of a user's current watching behavior regarding a plurality of program genres in a current time interval of a plurality of time intervals for a current time, analyze information of the user's current personal preference regarding the program genres in the current time interval of the plurality of time intervals for the current time according to the information of the user's current watching behavior, and generate, and provide via the display panel, one or more recommendations of programs available in the current time interval of the plurality of time intervals to the user according to the information of the user's current personal preference.

Based on the above, the program recommendation method is performed at the local machine/television and thus can be performed offline. In addition, local machine can identify different users by face recognition or other means and thus can perform machine learning to obtain personalized recommendation program lists for different users.

In addition, the program recommendation method provides the recommendations of programs available in the current time interval to the user according to the information of the user's current personal preference. That is to say, the time intervals are also considered in the program recommendation method. Further, the user's current personal preference is determined according to the user's current watching behavior and the user's past personal preference. Therefore, the suitable recommendation program list is provided to the users at different time intervals.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a user watching a program displayed by a local machine according to one embodiment of the disclosure.

FIG. 2 is a schematic view illustrating an electronic program guide shown in FIG. 1.

FIG. 3 is a schematic view showing a process of obtaining the weight of viewing time duration and the weight of number of select times according to the embodiment in FIG. 1.

FIG. 4 is a schematic view of a user setting a local machine according to another embodiment of the disclosure.

FIG. 5 is a schematic view showing a recommendation program list in FIG. 3.

FIG. 6 is a schematic view showing a recommendation program list according to another embodiment of the disclosure.

FIG. 7 is a schematic view showing distances between the favorite point and the program genres according to one embodiment of the disclosure.

FIGS. 8, 9A, 9B, 10, 11, 12, and 13 are a flow charts illustrating a program recommendation method according to one embodiment of the disclosure.

FIG. 14 is a flow chart illustrating a program recommendation method according to another embodiment of the disclosure.

### DESCRIPTION OF THE EMBODIMENTS

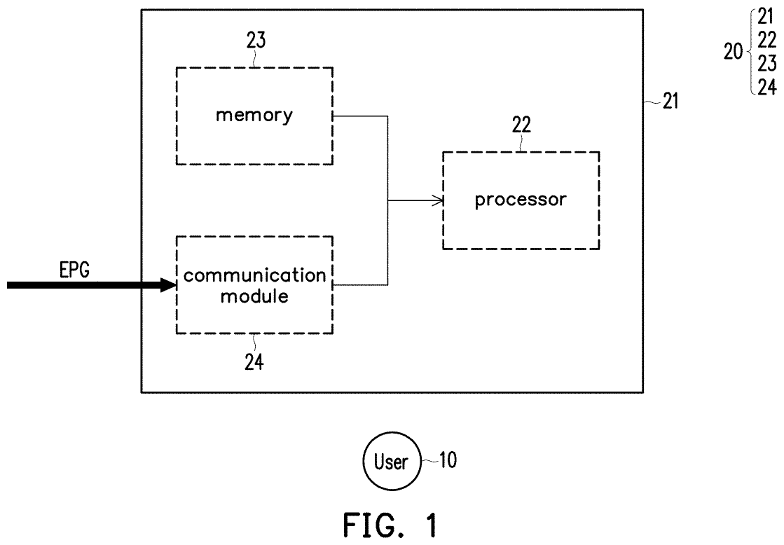

FIG. 1 is a schematic view of a user watching a program displayed by a local machine according to one embodiment of the disclosure. As shown in FIG. 1, a local machine 20 is a device that has the display function, such as a television. For convenience, the local machine 20 is called as the television 20 hereinafter. The television 20 includes a display panel 21, a processor 22, a memory 23, and a communication module 24. The display panel 21 of the television 20 is configured for display a program which is watched by a user 10.

The program displayed by the display panel 21 has information such as genre/name/actor/director, etc. The program genres may include program genre 1 (such as entertainment), program genre 2 (such as comedy), program genre 3 (such as movie), program genre 4 (such as drama), until program genre N. Wherein, N is an integer greater than 1. In addition, the communication module 24 is coupled to the processor 22. The communication module 24 is configured to receive a program guide, which may be an electronic program guide EPG. The electronic program guide EPG includes a plurality of programs each belonging to at least one of the program genres.

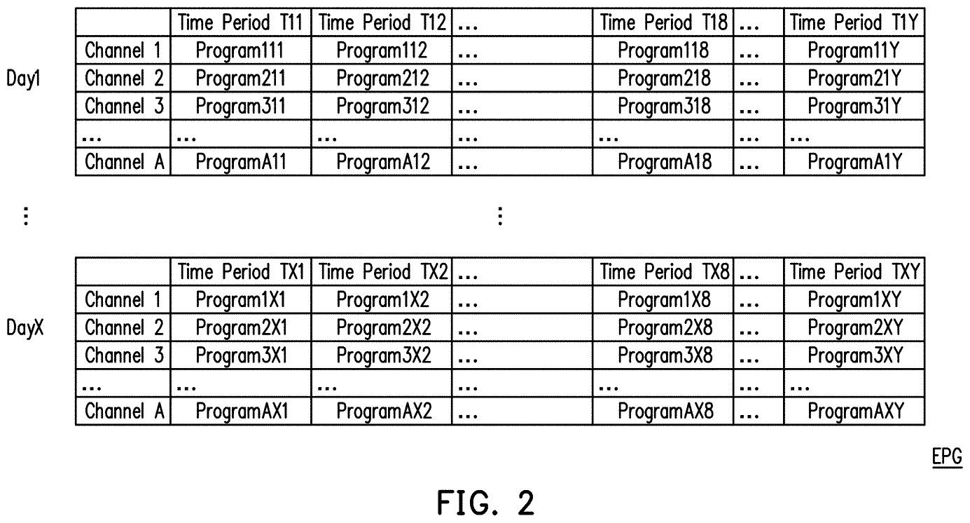

For example, FIG. 2 is a schematic view illustrating an electronic program guide shown in FIG. 1. As shown in FIG. 2, the electronic program guide EPG includes a plurality of programs 111 to AXY. Wherein, A means the number of channels and A is an integer greater than 0. In addition, X means the number of days and X is an integer greater than 0. Further, Y means the number of time periods/time intervals, and Y is also an integer greater than 0.

In this embodiment, X may be equal to 7 to represent a week. To be more specific, when X is equal to 1, it means the first day Day1, and the first day Day1 presents Monday. When X is equal to 2, it means the second day Day2, and the second day Day2 presents Tuesday. When X is equal to 3, it means the third day Day3, and the third day Day3 presents Wednesday. When X is equal to 4, it means the fourth day Day4, and the fourth day Day4 presents Thursday. When X is equal to 5, it means the fifth day Day5, and the fifth day Day5 presents Friday. When X is equal to 6, it means the sixth day Day6, and the sixth day D6 presents Saturday. Finally, when X is equal to 7, it means the seventh day Day7, and the seventh day Day7 presents Sunday. In addition, the value of Y is from 0 to 23, which means 24 hours indicated by the hours passed since midnight. For example, the program 313 is the program of the channel 3 is displayed on the television on Monday at 3 am. The time interval T11 means the first hour of the first day Day1 (Monday), the time interval T24 means the fourth hour of the second day Day2 (Tuesday), and so on. However, the disclosure is not limited thereto, other types of electronic program guide EPG can also be applied, and X and Y may have different values. In addition, the communication module 24 is configured to receive the information about the programs in one or more days in the electronic program guide EPG, the disclosure is not limited thereto.

In addition, the user 10 likes to watch different programs having different genres in different time intervals. Referring to FIG. 1 and FIG. 2 simultaneously, in the present embodiment, hypothetically, the user 10 watches the program 378, which is the program belongs to the channel 3 and is displayed by the television 20 at the time interval T78 (on Sunday at 8 am), and the current time interval is the time interval T78 which is Sunday at the time period from 8 to 9 am.

It should be noted here, the memory 23 is configured to store information of the user's past personal preference regarding a plurality of program genres 1 to N in a plurality of time intervals T11 to T77 for the past time. In other words, the information about the program genres of the programs which are watched by the user 10 in each of the time intervals T11 to T77 in the past time is stored in the memory 23, and this information is used as the past personal preference of the user 10.

The processor 22 is coupled to the memory 23 and the display panel 21. Further, the processor 22 is configured to obtain information of the user's current watching behavior regarding the program genres 1 to N in the current time interval T78 of the plurality of time intervals T11 to T723 for the current time. In other words, the information about the program genres of the programs (such as program 378) which are currently watched by the user 10 in the current time interval T78 is obtained by the processor 22 to be used as the current watching behavior of the user 10. Moreover, the processor 22 is configured to obtain, from the memory 23, the information of the user's past personal preference regarding the program genres 1 to N in one of the plurality of time intervals T11 to T77 corresponding to the current time interval T78 for the past time.

The user 10 probably likes different program genres in different time intervals. The program recommendation method can provide the recommendations of programs available in the current time interval to the user according to the information of the user's current personal preference. That is to say, the time intervals can be also considered in the program recommendation method. Therefore, the program recommendation method can provide recommendation considering the user's likes associated with different time intervals. Preferably but not limitedly, the user's current personal preference is determined according to not only the user's current watching behavior but also the user's past personal preference. Moreover, the information of the user's past personal preference can be updated using the information of the user's current personal preference. Consequently, the recommendation program list 310 can be updated in real time so as to be more suitable to be provided to the users at different time intervals. The details will be explained hereinafter.

Table 1 shows the values/factors considered in a time interval. As shown in Table 1, the program genres 1 to N are all considered in one time interval Txy. Each of the program genres 1 to N has its own parameters, such as temporary personal preference value Wtmp, past personal preference value Wold, watch time Swatch_time, and select time Sselect_ime, which are described in details hereinafter. It should be noted here, in the present embodiment, the current time interval is T78, it means that X is equal to 7 and Y is equal to 8.

TABLE 1
the values/factors considered in a time interval

| | | | | | |
|---|---|---|---|---|---|
| Txy | Genre 1 | Wold | Wtmp | Swatch_time | Sselect_time |
| Txy | . . . | . . . | . . . | . . . | . . . |
| Txy | Genre N | Wold | Wtmp | Swatch_time | Sselect_time |

In details, the information of the user's past personal preference includes a plurality of past personal preference values Wold respectively corresponding to the program genres 1 to N in the one of the plurality of time intervals corresponding to the current time interval T78 for the past time. The past personal preference value Wold is also called as the old weight Wold, which means the weight of the previous time interval. Table 2 shows the order in obtaining the past personal preference value Wold.

TABLE 2
the order in obtaining the past personal preference value

| Order | Trace Period | Time Interval |
|---|---|---|
| 1 | Same time interval last week | Txy |
| 2 | Same time interval yesterday | T(x − 1)y |
| 3 | Same time interval of all time | T0Y |
| 4 | All time | T00 |

In general, as shown in Table 2, if the current time interval is the time interval Txy, the past personal preference value Wold of each of the program genres 1 to N will be obtained in the sequence of the same time interval Txy of last week, the same time interval of yesterday T(x-1)y, the same time intervals of all time T0y, and the time intervals of all time T00. As long as the past personal preference value Wold is obtained, the obtaining process is ended. In the present embodiment, the current time interval is the time interval T78. The sequence of searching for the past personal preference value Wold is the time interval T78 of last week (Sunday at Sam of last week), the time interval T68 of yesterday (Saturday at 8 am of this week), the same time intervals of all time T08 (at 8 am of every day), the time intervals of all time T00 (every time interval of each day). Therefore, the past personal preference value Wold of one of the program genres 1 to N in the current time interval T78 is obtained from one of the time interval T78 of last week, the time interval T68 of yesterday, the same time intervals of all time T08, and the time intervals of all time T00.

Further, in the present embodiment, the information of the user's current watching behavior includes a plurality of temporary personal preference values respectively corresponding to the program genres 1 to N in the current time interval T78 of the plurality of time intervals T11 to T723 for the current time. Preferably but not limitedly, the temporary weight Wtmp can be served as the temporary personal preference value Wtmp. In addition, the information of the user's current watching behavior includes at least one of information of watch time Swatch_time and information of select time Sselect_time in the current time interval T78 of the plurality of time intervals T11 to T723 for the current time. In other words, the temporary personal preference value Wtmp of each of the program genres 1 to N is calculated according to the watch time Swatch_time and the select time Sselect_time, or the temporary personal preference value Wtmp of each of the program genres 1 to N is a function of the watch time Swatch_time and the select time Sselect_time. For example, the temporary personal preference value Wtmp of each of the program genres 1 to N may be calculated by normalization according to the sums of the watch time Swatch_time and the select time S select time. To be more specific, in each of the program genres 1 to N, the sum of the watch time Swatch_time and the select time Sselect_time is calculated, so as to obtain a plurality of sums S1 to SN. The maximum value of the sums S1 to SN is selected to be the maximum sum max(S). Hence, in each of the program genres 1 to N, the temporary personal preference value Wtmp is calculated by the following equation:

Wtmp=(Swatch_time+Sselect_time)/max(S)

Based on the above, the temporary personal preference value Wtmp of each of the program genres 1 to N is smaller than or equal to 1. That is to say, the temporary personal preference values Wtmp of the program genres 1 to N are normalized.

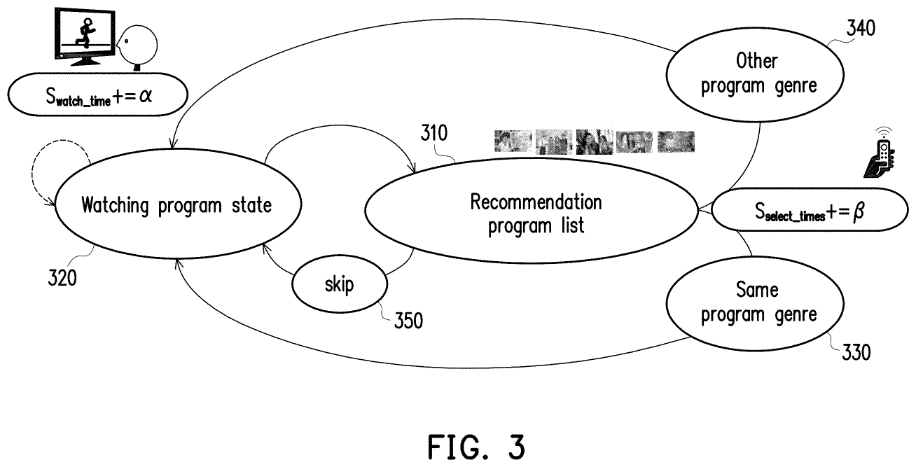

Hereinafter, the watch time Swatch_time and the select time Sselect_time will be further described. The watch time Swatch_time is determined according to the weight of viewing time duration α, and the select time Sselect_time is determined according to the weight of number of select times β. FIG. 3 is a schematic view showing a process of obtaining the weight of viewing time duration and the weight of number of select times according to the embodiment in FIG. 1. As shown in FIG. 3, after the user 10 selects a program in a recommendation program list 310, the program genre of the selected program is known, and the user 10 enters a watching program state 320. The time duration that the user watches the program on television 20 is recorded. Therefore, in each of the time intervals T11 to Txy, the total time duration that the user 10 spends for each of the program genres 1 to N is recorded and set as the weight of viewing time duration α. That is to say, the weight of viewing time duration α of one of the program genres 1 to N in a time interval is the total time duration that the user 10 watches a program of that one of the program genres 1 to N in that time interval. For example, in the time interval T24, the user 10 spends a total time duration of 0.5 hours to watch a comedy program. Hence, the weight of viewing time duration α of the program genre 2 (comedy) in the time interval T24 is 0.5, as an example. In other embodiments, the total time duration may be measured in minutes of seconds, the disclosure is not limited thereto. In the present embodiment, the watch time Swatch_time is accumulated by adding the value of the weight of viewing time duration α, such as by the equation Swatch_time+=α. However, the present disclosure is not limited thereto.

Further, as shown in FIG. 3, the weight of number of select times β is determined according to the number of times that the user 10 selects one program genre in the recommendation program list 310. There are three kinds of behaviors of the user 10, and the three kinds of behaviors will be defined hereinafter. In the first kind of behaviors, the user 10 selects the same program genre to watch, it is presumed that the user 10 likes this type of program genre and the weight of number of select times β is increased. To be more specific, in case that the user 10 continuously selects the same program genre one time or performs the first action 330 one time, the weight of number of select times β is accumulated or increased, and the weight of number of select times β is equal to 2. In case that the user continuously selects the same program genre two times or performs the first action 330 two times, the weight of number of select times β is accumulated and increased, and the weight of number of select times β is equal to 3. In case that the user continuously selects the same program genre three times or more or performs the first action 330 three times or more, the weight of number of select times β is accumulated and increased, and the weight of number of select times β is equal to 4. However, the disclosure is not limited thereto. In other embodiment, the weight of number of select times β may be accumulated in many different ways.

In the second kind of behaviors, the user 10 selects a different program genre or another program genre to watch or performs the second action 340. That is to say, the user 10 browses other program genres. The weight of number of select times β is reset, for example, the weight of number of select times β is equal to 2. In the third kind of behaviors, the user 10 skips the recommendation program list 310 or performs the third action 350. That is to say, the user 10 does not find any favorite program in the recommendation program list 310. In case that the user continuously skips the recommendation program list 310 more than three times, it indicates that the recommendation program list 310 does not have the program genre that the user likes at that time period. The first three program genres having the highest weights of number of select times β are downgraded. For example, the weights of number of select times β of the first three program genres are multiplied by 0.6, so as to be decreased. That is to say, the three highest weights of number of select times β are decreased. Next, three of the remaining program genres are randomly picked and upgraded. For example, the weights of number of select times β of three random program genres are multiplied by 0.8 or more. In this way, the exposure and appearance of other program genres can be dynamically changed and increased, thereby exploring the favorite program genres of the user 10 at different time intervals. However, the calculating method to downgrade and upgrade the program genres are not limited in the disclosure. In the present embodiment, the select time Sselect_time is accumulated by adding the value of the weight of number of select times β, such as by the equation Sselect_time+=β. However, the present disclosure is not limited thereto.

In the present embodiment, after the weight of viewing time duration α and the weight of number of select times β are determined, the watch time Swatch_time and the select time Sselect_time of each of the program genres 1 to N in the current time interval T78 are also determined. Consequently, the temporary personal preference values Wtmp of the program genres 1 to N in the current time interval T78 are obtained by normalization, as an example.

Next, the processor 22 analyzes the information of the user's current personal preference regarding the program genres 1 to N in the current time interval T78 of the plurality of time intervals T11 to T723 for the current time according to the information of the user's current watching behavior and the obtained information of the user's past personal preference. That is to say, the information of the user's current personal preference of each of the program genres 1 to N in the current time interval T78 are obtained. To be more specific, the information of the user's current personal preference includes a plurality of current personal preference values Wcurrent respectively corresponding to the program genres 1 to N in the current time interval T78 of the plurality of time intervals T11 to T723 for the current time. Preferably but not limitedly, the current weight Wcurrent can be served as the current personal preference value Wcurrent. In addition, the processor 22 is configured to calculate each one of the current personal preference values Wcurrent corresponding to one of the program genres 1 to N according to one of the temporary personal preference values Wtmp corresponding to the same one of the program genres 1 to N and one of the past personal preference values Wold corresponding to the same one of the program genres 1 to N. That is to say, the current personal preference value Wcurrent of the program genre 1 is calculated according to the temporary personal preference value Wtmp of the program genre 1 and the past personal preference values Wold of the program genre 1. The current personal preference value Wcurrent of the program genre 2 is calculated according to the temporary personal preference value Wtmp of the program genre 2 and the past personal preference values Wold of the program genre 2, and so on.

In particular, the processor 22 is configured to assign weights γ and (1-γ) to the one of the past personal preference values Wold and the one of the temporary personal preference values Wtmp. Wherein, γ is a real number which is greater than or equal to zero and smaller than or equal to one. In the present embodiment, 0.5 is set as a default value of γ. Next, the processor 22 is configured to calculate the current personal preference values Wcurrent according to the one of the past personal preference values Wold, the one of the temporary personal preference values Wtmp and the weights γ and (1-γ) assigned thereto. That is to say, for each of the program genres 1 to N in the current time interval T78, the current personal preference value Wcurrent is obtained according to the past personal preference value Wold, the temporary personal preference value Wtmp, and the weights γ and (1-γ). Specifically, the current personal preference value Wcurrent of each of the program genres 1 to N is calculated by the following equation:

Wcurrent=γ*Wold+(1-γ)*Wtmp

Accordingly, the user 10 can change the tendency to recommend the programs towards the past or towards the current time interval according to personal preference by adjusting the value of the weight γ. For example, the user 10 can change the tendency towards the past by setting the weight γ as 0.6, and the user 10 can change the tendency towards the current time interval by setting the weight γ as 0.4.

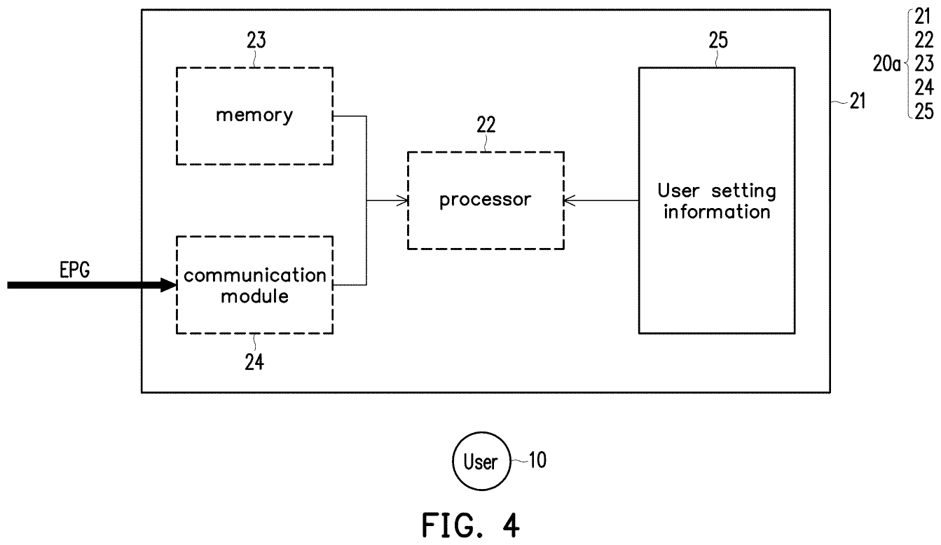

FIG. 4 is a schematic view of a user setting a local machine according to another embodiment of the disclosure. The television 20a in present embodiment is similar to the television 20 in FIG. 1, only the differences are described hereinafter. In the present embodiment, the television 20a further includes a user interface 25 coupled to the processor 22 and configured to acquire user setting information, wherein the processor 22 assigns the weights γ and (1-γ) to the one of the past personal preference values Wold and the one of the temporary personal preference values Wtmp based on the user setting information. That is to say, the user 10 sets the weights γ and (1-γ) for the past personal preference values Wold and the temporary personal preference values Wtmp of each of the program genres 1 to N through the user interface 25 of the television 20a.

Returning to the embodiment in FIGS. 1 to 3, the processor 22 is further configured to assign a default value W′ to the current personal preference value Wcurrent corresponding to a current program genre of the program genres 1 to N before the user changes the current program genre. The current program genre is the program genre to which a program currently watched by the user and the default value W′ is greater than each of the current personal preference values corresponding to the other ones of the program genres 1 to N in the current time interval T78 of the plurality of time intervals T11 to TXY. To be more specific, the default value W′ is greater than 1 and is set as 1.5 by default. For example, in the current time interval T78, the user 10 is watching the program 378, and the program 378 has the program genre 1 (such as entertainment). Therefore, the current program genre is the program genre 1, and the default value W′ is assigned to the current personal preference value Wcurrent of the current program genre 1 in the time interval T78. Since the default value W′ is set as 1.5, the current personal preference value Wcurrent of the current program genre 1 is greater than each of the current personal preference values Wcurrent (which are all smaller than 1) of the program genres 2 to N in the current time interval T78. Consequently, the programs having the program genre 1 are placed on the top of the recommendation program list 310.

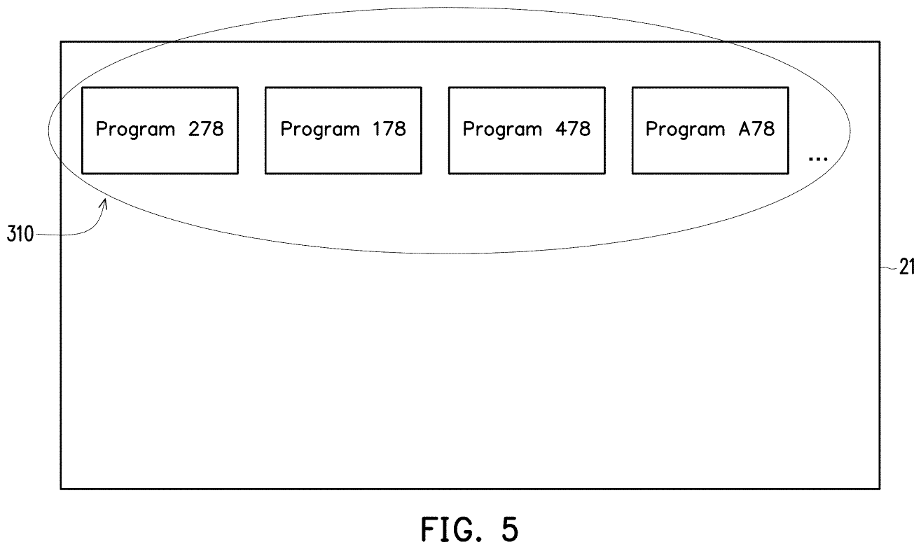

FIG. 5 is a schematic view showing a recommendation program list in FIG. 3. The processor 22 generates and provides, via the display panel 21, one or more recommendations of programs available in the current time interval T78 of the plurality of time intervals T11 to T723 to the user 10 according to the information of the user's current personal preference. The recommendation program list 310 includes the recommendations of the programs. For example, in the current time interval T78, the user 10 is watching the program 378 of the channel 3. Hence, the recommendation program list 310 may include the program 278 of the channel 2, the program 178 of the channel 1, the program 478 of the channel 4, the program A78 of the channel A, etc.

Further, the processor 22 is configured to recommend one or more programs available in the current time interval T78 belonging to one or more of the program genres 1 to N corresponding to higher current personal preference values Wcurrent. For example, the program 378 that the user 10 is watching in the current time interval T78 has the program genre 1. The program 278 of the channel 2 also has the program genre 1, so the default value W′=1.5 is assigned to the current personal preference value Wcurrent of the program 278. After calculation as mentioned above, the program 178 of the channel 1 has the program genre 2 and has the current personal preference values Wcurrent of 0.8. The program 478 of the channel 4 has the program genre 3 and has the current personal preference values Wcurrent of 0.5. The program A78 of the channel A has the program genre 3 and has the current personal preference values Wcurrent of 0.2. Hence, as shown in FIG. 5, the recommending sequence in the recommendation program list 310 is the program 278, the program 178, the program 478, and the program A78. That is to say, in the current time interval T78, the programs having higher current personal preference values Wcurrent are recommended first.

Based on the above, the program recommendation method is performed by the display panel 21, the processor 22, the memory 23, and the communication module 24 of the television 20 which is a local machine or end machine. That is to say, the program recommendation method is performed at the local machine 20 and thus can be performed offline. In addition, local machine 20 can identify different users 10 by face recognition or other means and thus can perform machine learning to obtain personalized recommendation program lists 310 for different users 10.

Moreover, the processor 22 is further configured to update the information of the user's past personal preference stored in the memory 23 using the information of the user's current personal preference. To be more specific, in the current time interval T78, the past personal preference value Wold of each of the program genres 1 to N is updated by the current personal preference value Wcurrent of that program genre. It is represented by the following equation:

Wold=Wcurrent

It should be noted here, in the present embodiment, the programs are recommended according to the program genre, but the disclosure is not limited thereto. In other embodiments, the programs may be recommended according to other program information, such as actor, director, name, etc.

In summary, the user 10 probably likes different program genres in different time intervals. The program recommendation method provides the recommendations of programs available in the current time interval to the user according to the information of the user's current personal preference. That is to say, the time intervals are also considered in the program recommendation method. Therefore, the program recommendation method can provide recommendation considering the user's likes associated with different time intervals. Further, the user's current personal preference can be determined according to not only the user's current watching behavior but also the user's past personal preference. Moreover, the information of the user's past personal preference can be updated using the information of the user's current personal preference. Therefore, the recommendation program list can be updated in real time so as to be more suitable to be provided to the users at different time intervals.

FIG. 6 is a schematic view showing a recommendation program list according to another embodiment of the disclosure. A recommendation program list 310a in the present embodiment is formed in a similar way to the recommendation program list 310 in the previous embodiment, only the differences are described hereinafter. In the present embodiment, the processor 22 is further configured to search one or more online videos Youtube1 to YoutubeN according to the one or more recommendations of programs provided via the display panel 21. Wherein, N is an integer greater than 1. The processor 22 is further configured to provide, via the display panel 21 of the television 20, the one or more online videos Youtube1 to YoutubeN to the user 10, as shown in FIG. 6. That is to say, compared to the recommendation program list 310, the recommendation program list 310a further includes the online videos Youtube1 to YoutubeN.

However, in another way, the processor 22 is further configured to search one or more online videos Youtube1 to YoutubeN according to the information of the user's current personal preference regarding the program genres 1 to N in the current time interval T78 of the plurality of time intervals T11 to T723 for the current time. The processor 22 is further configured to provide, via the display panel 21 of the television 20, the one or more online videos Youtube1 to YoutubeN to the user 10. For example, more other episodes available online for the same recommend television program(s) can be served as the online recommended programs since there may be more online episodes for the same programs.

In other words, the sources of programs to be recommended can be not limited to television channels but any online (e.g. internet) sources. The use's preference associated with television programs can be used not to recommend television programs. The processor 22 can be configured to provide additional recommendation for online programs based on user's preference associated with television programs. In another embodiment, only the online programs are shown in another recommendation program list.

In another embodiment of the disclosure, in the television 20, the processor 22 is also coupled to the display panel 21. The processor 22 is configured to obtain information of the user's current watching behavior regarding a plurality of program genres 1 to N in a current time interval of a plurality of time intervals T11 to T723 for the current time. The processor 22 is configured to analyze information of the user's current personal preference regarding the program genres 1 to N in the current time interval of the plurality of time intervals T11 to T723 for the current time according to the information of the user's current watching behavior. However, the processor 22 is configured to generate, and provide via the display panel 21, one or more recommendations of programs available in the current time interval of the plurality of time intervals T11 to T723 to the user according to the information of the user's current personal preference.

In other words, the recommendations of programs are based on only the current personal preference values Wcurrent of the program genres 1 to N in the current time interval. For example, the user 10 is watching the television 20 in the time interval T214 (on Tuesday, 2 pm). In the time interval T214, there are 5 program genres. The program genre 1 is entertainment, the program genre 2 is comedy, the program genre 3 is movie, the program genre 4 is drama, and the program genre 5 is Talk Show. It is assumed as follows. With respect to program genre 1 (entertainment), the watch time Swatch_time is equal to 5 and the select time Sselect_time is equal to 4. With respect to the program genre 2 (comedy), the watch time Swatch_time is equal to 10 and the select time Sselect_time is equal to 2. With respect to genre 3 (movie), the watch time Swatch_time is equal to 30 and the select time Sselect_time is equal to 2. The program genre 4 (drama) and the program genre 5 (Talk Show) are not watched by the user 10, so both the watch time Swatch_time and the select time Sselect_time of the program genre 4 and the program genre 5 are equal to zero. The sum of the watch time Swatch_time and the select time Sselect_time of the program genre3 is equal to the sum of 30 and 2 and thus is equal to 32, which is the highest. After normalization, the current personal preference value Wcurrent of the program genre 1 is equal to (4+5) divided by 32 and thus is equal to 0.28. The current personal preference value Wcurrent of the program genre 2 is equal to (10+2) divided by 32 and thus is equal to 0.375. The current personal preference value Wcurrent of the program genre 3 is equal to (30+2) divided by 32 and thus is equal to 1. The current personal preference value Wcurrent of the program genre 4 is equal to (0+0) divided by 32 and thus is equal to 0. The current personal preference value Wcurrent of the program genre 5 is equal to (0+0) divided by 32 and thus is equal to 0. Table 5 shows the normalization of the current personal preference values of the program genres as mentioned above.

TABLE 5
Normalization of the current personal preference values of the program genres.

| Time interval T214 | Entertainment | Comedy | Movie | Drama | Talk Show |
|---|---|---|---|---|---|
| Sum | 5 + 4 | 10 + 12 | 30 + 2 | 0 | 0 |
| Normalization | 9/32 = 0.28 | 12/32 = 0.375 | 32/32 = 1 | 0/32 = 0 | 0/32 = 0 |

After that, the favorite point which is a matrix of the normalized current personal preference values and the matrix of the program genres are formed and the projected into two dimensional space by singular value decomposition. As such, after the projection, the matrix of the favorite point is [0.28 0.375 1 0 0], the matrix of program genre 1 (entertainment) is [1 0 0 0 0], the matrix program genre 2 is [0 1 0 0 0], the matrix program genre 3 is [0 0 1 0 0], the matrix program genre 4 is [0 0 0 1 0], and the matrix program genre 5 is [0 0 0 0 1]. The position of the favorite point is closest to the position of the program having program genre 3 so the programs having the program genre 3 in the same time interval T214 are recommended first. Hence, the programs are recommended according to the distance to the favorite point.

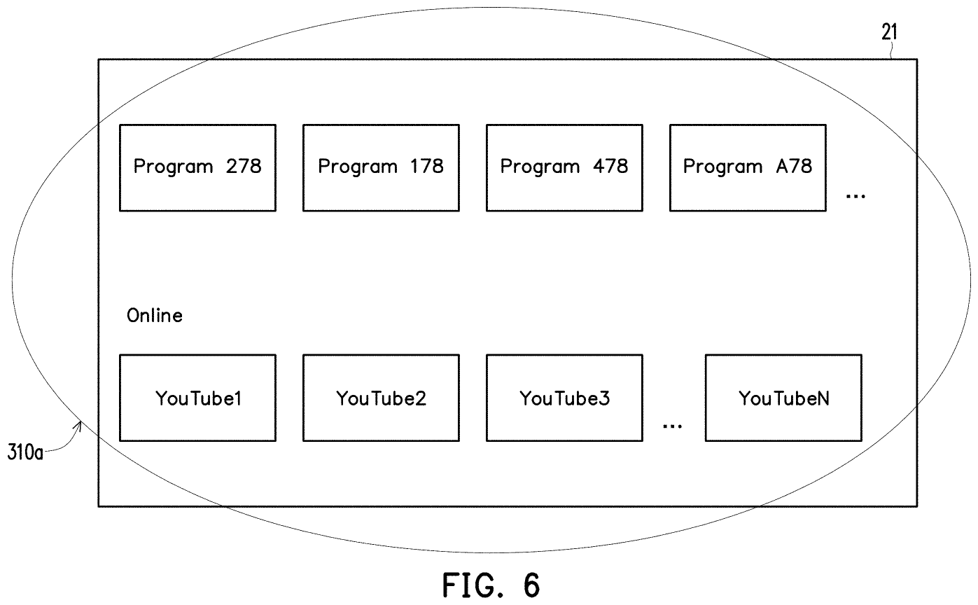

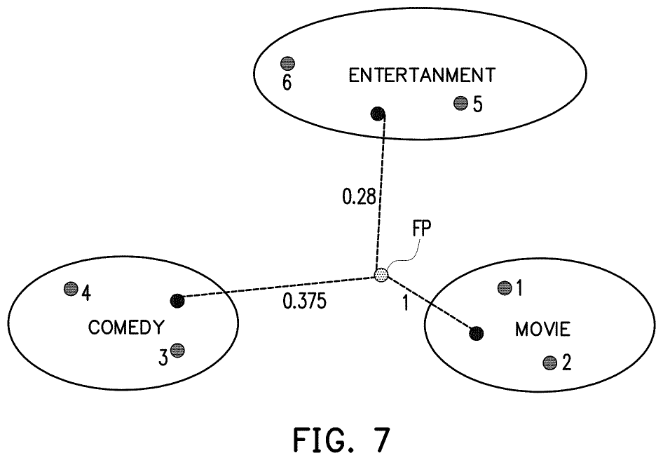

FIG. 7 is a schematic view showing distances between the favorite point and the program genres according to one embodiment of the disclosure. As shown in FIG. 7, the distance from the favorite point FP to the program genre 3 (movie) is the shortest distance, the distance from the favorite point FP to the program genre 1 (entertainment) is the longest distance, and the distance from the favorite point FP to the program genre 2 (comedy) is the medium distance. Therefore, the sequence in the recommendation program list is the programs 1 and 2 having the program genre 3, the programs 3 and 4 having the program genre 2, and the programs 5 and 6 having the program genre 1.

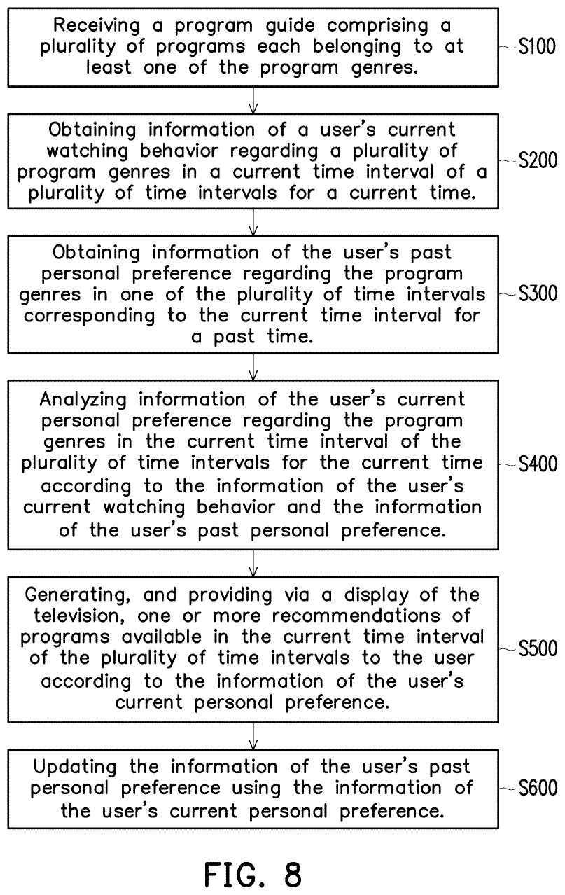

FIGS. 8, 9A, 9B, 10, 11, 12, and 13 are flow charts illustrating a program recommendation method according to one embodiment of the disclosure. The program recommendation method is applicable to any one of the televisions 20 and 20a described above. For convenience of explanation, only the television 20 is mentioned as an example. As shown in FIG. 8, in step S100, a program guide EPG including a plurality of programs each belonging to at least one of the program genres 1 to N is received. In step S200, the information of the user's current watching behavior regarding a plurality of program genres 1 to N in the current time interval (such as the time interval T78) of a plurality of time intervals T11 to T723 for the current time is obtained. Next, in step S300, the information of the user's past personal preference regarding the program genres 1 to N in one of the plurality of time intervals T11 to T77 corresponding to the current time interval for the past time is obtained. In step S400, the information of the user's current personal preference regarding the program genres 1 to N in the current time interval of the plurality of time intervals T11 to T723 for the current time is analyzed according to the information of the user's current watching behavior and the information of the user's past personal preference. In step S500, one or more recommendations of programs available in the current time interval of the plurality of time intervals T11 to T723 are generated and provided, via the display panel 21 of the television 20, to the user 10 according to the information of the user's current personal preference. Further, in step S600, the information of the user's past personal preference is updated using the information of the user's current personal preference.

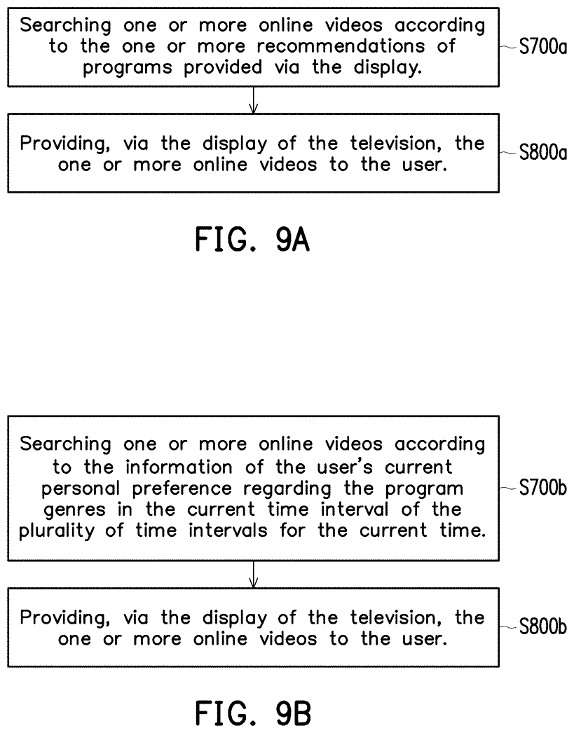

Sequentially, the program recommendation method may further includes the steps in FIG. 9A or FIG. 9B. To be more specific, as shown in FIG. 9A, in Step 700a, one or more online videos are searched according to the one or more recommendations of programs provided via the display panel 21. Next, the one or more online videos are provided, via the display 21 of the television 20, to the user 10 in step S800a. In another way, as shown in FIG. 9B, in Step 700b, one or more online videos are searched according to the information of the user's current personal preference regarding the program genres in the current time interval of the plurality of time intervals for the current time. Furthermore, the one or more online videos are provided, via the display panel 21 of the television 20, to the user 10. That is to say, the online videos are also recommended to the user 10. It should be noted here, the information of the user's current watching behavior comprises at least one of information of watch time Swatch_time and information of select times Sselect_time in the current time interval of the plurality of time intervals T11 to T723 for the current time, as mentioned above.

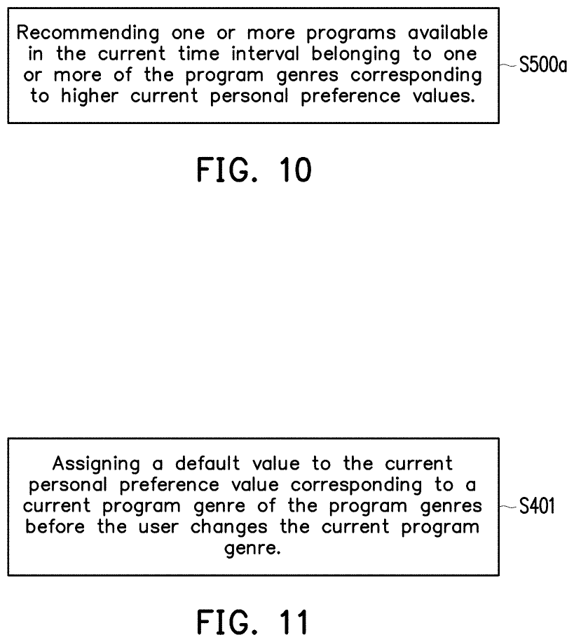

Further, as mentioned above, the information of the user's current personal preference regarding the program genres 1 to N in the current time interval T78 of the plurality of time intervals T11 to T723 for the current time includes a plurality of current personal preference values Wcurrent respectively corresponding to the program genres 1 to N in the current time interval T78 of the plurality of time intervals T11 to T723 for the current time. The step S500 includes the step S500a. As shown in FIG. 10, in the step S500a, one or more programs available in the current time interval T78 belonging to one or more of the program genres 1 to N corresponding to higher current personal preference values Wcurrent are recommended to the user 10. The program recommendation method further includes a step S401 between the step S400 and the step S500. As shown in FIG. 11, in Steps S401, a default value W′ is assigned to the current personal preference value Wcurrent corresponding to a current program genre of the program genres 1 to N before the user 10 changes the current program genre.

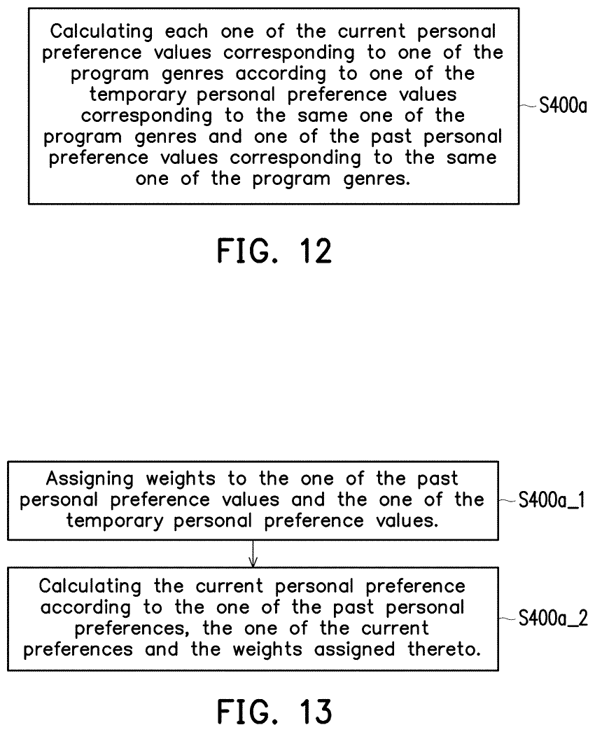

As mentioned above, the information of the user's current watching behavior includes a plurality of temporary personal preference values Wtmp, and the information of the user's past personal preference includes a plurality of past personal preference values Wold. The step S400 of the program recommendation method further includes a step S400a. As shown in FIG. 12, in step S400a, each one of the current personal preference values Wcurrent is calculated corresponding to one of the program genres 1 to N according to one of the temporary personal preference values Wtmp corresponding to the same one of the program genres 1 to N and one of the past personal preference values Wold corresponding to the same one of the program genres 1 to N. To be more specific, the step S400a includes two steps S400a_1 and S400a_2. As shown in FIG. 13, in the step S400a_1, the weights γ and (1-γ) are assigned to the one of the past personal preference values Wold and the one of the temporary personal preference values Wtmp. For example, the weights γ and (1-γ) are assigned based on user setting information. Additionally, the step S400a_2, the current personal preference value Wcurrent is calculated according to the one of the past personal preference values Wold, the one of the temporary personal preference values Wtmp and the weights γ and (1-γ) assigned thereto.

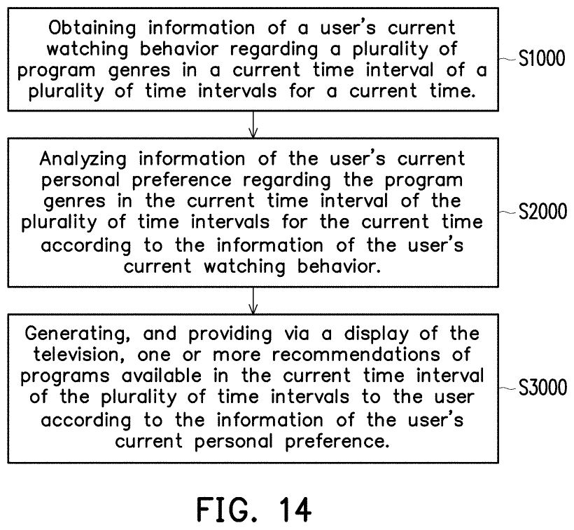

FIG. 14 is a flow chart illustrating a program recommendation method according to another embodiment of the disclosure. In the present embodiment, the program recommendation method only includes three steps: S1000, S2000, and S3000. As shown in FIG. 14, in step S1000, information of the user's current watching behavior regarding a plurality of program genres 1 to N in the current time interval (such as the current time interval T78) of a plurality of time intervals T11 to T723 for the current time is obtained. In step S2000, information of the user's current personal preference regarding the program genres 1 to N in the current time interval of the plurality of time intervals T11 to T723 for the current time is analyzed according to the information of the user's current watching behavior. Next, in step 53000, one or more recommendations of programs available in the current time interval of the plurality of time intervals are generated and provided, via the display panel 21 of the television 20, to the user 10 according to the information of the user's current personal preference.

Summarily, the program recommendation method is performed by the display panel, the processor, the memory, and the communication module of the television which is a local machine or end machine. That is to say, the program recommendation method is performed at the local machine and thus can be performed offline. In addition, local machine can identify different users by face recognition or other means and thus can perform machine learning to obtain personalized recommendation program lists for different users.

In addition, the user likes different program genres in different time intervals. The program recommendation method provides the recommendations of programs available in the current time interval to the user according to the information of the user's current personal preference. That is to say, the time intervals are also considered in the program recommendation method. Preferably but not limitedly, the user's current personal preference can be determined according to the user's current watching behavior and the user's past personal preference. Moreover, the information of the user's past personal preference can be updated using the information of the user's current personal preference. Consequently, the suitable recommendation program list is provided to the users at different time intervals.

Further, the recommendation program list may further include the online videos found on the internet.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A program recommendation method applicable to a television, comprising:
obtaining information of a user's current watching behavior regarding a plurality of program genres in a current time interval of a plurality of time intervals for a current time;
obtaining information of the user's past personal preference regarding the program genres in one of the plurality of time intervals corresponding to the current time interval for a past time;
analyzing information of the user's current personal preference regarding the program genres in the current time interval of the plurality of time intervals for the current time according to the information of the user's current watching behavior and the information of the user's past personal preference; and
generating, and providing via a display of the television, one or more recommendations of programs available in the current time interval of the plurality of time intervals to the user according to the information of the user's current personal preference.

2. The program recommendation method according to claim 1, further comprising updating the information of the user's past personal preference using the information of the user's current personal preference.

3. The program recommendation method according to claim 1, further comprising receiving a program guide comprising a plurality of programs each belonging to at least one of the program genres.

4. The program recommendation method according to claim 1, wherein the information of the user's current personal preference regarding the program genres in the current time interval of the plurality of time intervals for the current time comprises a plurality of current personal preference values respectively corresponding to the program genres in the current time interval of the plurality of time intervals for the current time.

5. The program recommendation method according to claim 4, wherein the step of generating, and providing via the display of the television, the one or more recommendations of programs available in the current time interval of the plurality of time intervals to the user according to the information of the user's current personal preference comprises:
recommending one or more programs available in the current time interval belonging to one or more of the program genres corresponding to higher current personal preference values.

6. The program recommendation method according to claim 4, wherein
the information of the user's current watching behavior regarding the program genres in the current time interval of the plurality of time intervals for the current time comprises a plurality of temporary personal preference values respectively corresponding to the program genres in the current time interval of the plurality of time intervals for the current time, and
the information of the user's past personal preference regarding to the program genres in the one of the plurality of time intervals corresponding to the current time interval for the past time comprises a plurality of past personal preference values respectively corresponding to the program genres in the one of the plurality of time intervals corresponding to the current time interval for the past time.

7. The program recommendation method according to claim 6, wherein the step of analyzing the information of the user's current personal preference regarding the program genres in the current time interval of the plurality of time intervals for the current time according to the information of the user's current watching behavior and the information of the user's past personal preference comprises:
calculating each one of the current personal preference values corresponding to one of the program genres according to one of the temporary personal preference values corresponding to the same one of the program genres and one of the past personal preference values corresponding to the same one of the program genres.

8. The program recommendation method according to claim 1, wherein the information of the user's current watching behavior comprises at least one of information of watch time and information of select times in the current time interval of the plurality of time intervals for the current time.

9. The program recommendation method according to claim 7, wherein the step of calculating each one of the current personal preference values corresponding to the one of the program genres according to the one of the temporary personal preference values corresponding to the same one of the program genres and the one of the past personal preference values corresponding to the same one of the program genres comprises:
assigning weights to the one of the past personal preference values and the one of the temporary personal preference values; and
calculating the current personal preference according to the one of the past personal preferences, the one of the temporary personal preference values and the weights assigned thereto.

10. The program recommendation method according to claim 9, wherein the step of assigning weights to the one of the past personal preference values and the one of the temporary personal preference values is performed based on user setting information.

11. The program recommendation method according to claim 4, further comprising:
assigning a default value to the current personal preference value corresponding to a current program genre of the program genres before the user changes the current program genre,
wherein the current program genre is the program genre to which a program currently watched by the use belongs and the default value is greater than each of the current personal preference values corresponding to the other ones of the program genres in the current time interval of the plurality of time intervals.

12. The program recommendation method according to claim 1, further comprising:
searching one or more online videos according to the one or more recommendations of programs provided via the display; and
providing, via the display of the television, the one or more online videos to the user.

13. The program recommendation method according to claim 1, further comprising:
searching one or more online videos according to the information of the user's current personal preference regarding the program genres in the current time interval of the plurality of time intervals for the current time; and
providing, via the display of the television, the one or more online videos to the user.

14. A program recommendation method applicable to a television, comprising:
obtaining information of a user's current watching behavior regarding a plurality of program genres in a current time interval of a plurality of time intervals for a current time;
analyzing information of the user's current personal preference regarding the program genres in the current time interval of the plurality of time intervals for the current time according to the information of the user's current watching behavior; and
generating, and providing via a display of the television, one or more recommendations of programs available in the current time interval of the plurality of time intervals to the user according to the information of the user's current personal preference.

15. A television comprising:
a display panel;
a memory configured to store information of a user's past personal preference regarding a plurality of program genres in a plurality of time intervals for a past time; and
a processor coupled to the memory and the display panel, and configured to:
obtain information of the user's current watching behavior regarding the program genres in a current time interval of the plurality of time intervals for a current time;
obtain, from the memory, the information of the user's past personal preference regarding the program genres in one of the plurality of time intervals corresponding to the current time interval for the past time;
analyze information of the user's current personal preference regarding the program genres in the current time interval of the plurality of time intervals for the current time according to the information of the user's current watching behavior and the obtained information of the user's past personal preference; and
generate and provide, via the display panel, one or more recommendations of programs available in the current time interval of the plurality of time intervals to the user according to the information of the user's current personal preference.

16. The television according to claim 15, wherein the processor is further configured to update the information of the user's past personal preference stored in the memory using the information of the user's current personal preference.

17. The television according to claim 15, further comprising:
a communication module coupled to the processor and configured to receive a program guide comprising a plurality of programs each belonging to at least one of the program genres.

18. The television according to claim 15, wherein the information of the user's current personal preference regarding the program genres in the current time interval of the plurality of time intervals for the current time comprises a plurality of current personal preference values respectively corresponding to the program genres in the current time interval of the plurality of time intervals for the current time.

19. The television according to claim 18, wherein when the processor generates and provides, via the display panel, the one or more recommendations of programs available in the current time interval of the plurality of time intervals to the user according to the information of the user's current personal preference, the processor is configured to:
recommend one or more programs available in the current time interval belonging to one or more of the program genres corresponding to higher current personal preference values.

20. The television according to claim 18, wherein the information of the user's current watching behavior regarding the program genres in the current time interval of the plurality of time intervals for the current time comprises a plurality of temporary personal preference values respectively corresponding to the program genres in the current time interval of the plurality of time intervals for the current time, and
the information of the user's past personal preference regarding to the program genres in the one of the plurality of time intervals corresponding to the current time interval for the past time comprises a plurality of past personal preference values respectively corresponding to the program genres in the one of the plurality of time intervals corresponding to the current time interval for the past time.

21. The television according to claim 20, wherein when the processor analyzes the information of the user's current personal preference regarding the program genres in the current time interval of the plurality of time intervals for the current time according to the information of the user's current watching behavior and the obtained information of the user's past personal preference, the processor is configured to:
calculate each one of the current personal preference values corresponding to one of the program genres according to one of the temporary personal preference values corresponding to the same one of the program genres and one of the past personal preference values corresponding to the same one of the program genres.

22. The television according to claim 15, wherein the information of the user's current watching behavior comprises at least one of information of watch time and information of select times in the current time interval of the plurality of time intervals for the current time.

23. The television according to claim 21, wherein when the processor calculates each one of the current personal preference values corresponding to the one of the program genres according to the one of the temporary personal preference values corresponding to the same one of the program genres and the one of the past personal preference values corresponding to the same one of the program genres, the processor is configured to:
assign weights to the one of the past personal preference values and the one of the temporary personal preference values; and
calculate the current personal preference according to the one of the past personal preferences, the one of the temporary personal preference values and the weights assigned thereto.

24. The television according to claim 23, further comprising:
a user interface coupled to the processor and configured to acquire user setting information,
wherein the processor assigns weights to the one of the past personal preference values and the one of the temporary personal preference values based on the user setting information.

25. The television according to claim 18, wherein the processor is further configured to:
assign a default value to the current personal preference value corresponding to a current program genre of the program genres before the user changes the current program genre,
wherein the current program genre is the program genre to which a program currently watched by the use belongs and the default value is greater than each of the current personal preference values corresponding to the other ones of the program genres in the current time interval of the plurality of time intervals.

26. The television according to claim 15, wherein the processor is further configured to:
search one or more online videos according to the one or more recommendations of programs provided via the display; and
provide, via the display of the television, the one or more online videos to the user.

27. The television according to claim 15, wherein the processor is further configured to:
search one or more online videos according to the information of the user's current personal preference regarding the program genres in the current time interval of the plurality of time intervals for the current time; and
provide, via the display of the television, the one or more online videos to the user.

28. A television, comprising:
a display panel; and
a processor coupled to the display panel and configured to:
obtain information of a user's current watching behavior regarding a plurality of program genres in a current time interval of a plurality of time intervals for a current time;
analyze information of the user's current personal preference regarding the program genres in the current time interval of the plurality of time intervals for the current time according to the information of the user's current watching behavior; and
generate, and provide via the display panel, one or more recommendations of programs available in the current time interval of the plurality of time intervals to the user according to the information of the user's current personal preference.
